(19) United States
(12) Patent Application Publication
(10) Pub. No.: US 2004/0100207 A1
(43) Pub. Date: May 27, 2004

(54) Device for switching on and powering discharge lamps

(76) Inventors: Fabio DeSisti, Cecchina (IT); Mario DeSisti, Cecchina (IT)

Correspondence Address: ARLENE J. POWERS, GAUTHIER & CONNORS LLP, 225 FRANKLIN STREET, SUITE 3300, BOSTON, MA, 02110, US

(21) Appl. No.: 10/712,848

(22) Filed: Nov. 13, 2003

(30) Foreign Application Priority Data
Nov. 25, 2002 (IT) RM2002A000594

(51) Int. Cl. H05B 37/02

(52) U.S. Cl. 315/276; 315/209 T; 315/220; 315/212

(57) ABSTRACT

The invention relates to a device (101) for switching on and powering discharge lamps comprising at least a current limiting device, at least a square wave generator, at least an igniter, at least two high tension connection cables (107, 107′), at least a lamp holder (103) with at least a discharge lamp (104) coupled, said at least one igniter comprising at least a high tension transformer and at least an overlapping transformer, said device being characterised in that said at least an igniter is divided into a first stage of the igniter, or pulse generator transformer (102), and a high tension transformer (108), and in that said first igniter stage, or pulse generator transformer (102), and the relevant high tension transformer (108) are assembled along with the above mentioned components.

The present invention concern an improved device for switching on and powering discharge lamps.

More particularly, the invention concerns a device suitable for discharge lamps, mainly employed for motionpicture and/or TV lighting, but that can be also used for each situation wherein discharge lamps with a high lighting efficiency are required.

### TECHNICAL BACKGROUND

As it is well known, at present, in the professional lighting engineering field, discharge lamps (metallic halide-iodide) are employed, characterised by high lighting efficiency (lumen per watt), even four times higher than those that can be obtained by conventional filament lamps, and by long lasting, even from 3 to 6 times longer than that of the standard lamps.

The chromatic features of the light emitted make the use of said lamps outdoor, where solar light is strong, are particularly good, since this kind of lamps can be calorimetric mixed with the day light, simplifying possible correction or balancing of the colours, necessary for the reading instruments (telecameras and cinecameras) or for the pleasure of perceiving the image by the human eye.

At present, lighting system for discharge lamps available on the market are comprised by:

a projector, housing the lamp, the optical system and the lighting device (igniter);

a voltage limiting device, known as “ballast”, housed within a suitably sized housing;

a multipolar cable connecting the two devices.

As to the igniters presently used for the discharge lamps, they are comprised of two main parts: a pulse generator and a overlapping transformer. Usually, all the components are mounted within a box housed within the base of the projector. From said box, two cables goes up to the lamp-holder. Said cables serve both to bring the power voltage, that can be up to 80 Ampere for the most powerful lamps, and the high voltage during the striking, that can be up to 75 Kvolt. Since the carriage on which the lamp-holder is fixed must be movable to adjust the focus, high voltage cables shall have a sufficient length, but will be subjected to wearing and to the risk to come in touch with metallic parts or to be hit by UV rays with the consequent fast deterioration and thus lost of insulation.

Above high powers are necessary to switch on the subject lamps. In fact, to this end, it is necessary to generate high tension pulses crossing to the loadless tension generated by the Ballast and present at the ends of the lamp, in order to pierce the dielectric between the electrodes. This switching on mode is particularly cumbersome when it is wished to switch on again a lamp just switched off. In fact, dielectric rigidity values are in this condition very high.

Usually, within the projector, lamp is mounted integral with an optical group that, for focusing reasons of the lighting beam, must be moved along an axis for a set distance, which is function of the same optical system (e.g. spot and flood Fresnel projectors: i.e. narrow beam light and large beam light). Igniter is usually mounted in the fixed part of the projector.

During the lamp switching on phase, igniter activates and generates quite high frequency tension pulses that, physically are transmitted to the lamp by cables, which are inside the projector.

Technique presently used provides the dimensioning of the cable between igniter and lamp in such a way to:

Guaranteeing the necessary insulation, that during the discharge lamp switching on phase must in some cases be higher than 40 kV toward the earth (ground), and considering that the use of these products provides humid, very cold or very hot environments, this problem not always is solved by the various manufacturers of this kind of lamps;

Guaranteeing the maximum flexibility, bearing in mind that the igniter is in a fixed position, that the lamp-lamp holder group moves to obtain focusing of the luminous beam and that spaces within the projector are very small, obviously also considering the power of the specific lamp;

Reducing at minimum the length: as previously described, during the switching on phase, igniter emits high tension as high frequency pulses. Lamps and/or igniters manufacturers describe in the technical specification of their products, a maximum length of the cables, since directly functional to the increase of the capacitive effect occurring at high frequency (a longer length of the cables introduces a higher capacitive effect during the switching on phase and thus a lower efficiency of the electrical parameters necessary to strike the arc within the lamp).

To solve the above problems, technique used until today in the specific industry is the use of special cables that can comply with the above functions, however not obtaining optimum results.

In fact, it is usual that high tension cables used in the discharge lamp projectors, since subjected to remarkable thermal exposure, stroked by relevant UV doses and often subjected to movement within narrow spaces (focusing), are among the components that earlier wearing in this kind of product.

Fast deterioration of these cables further introduces a noticeable problem of unreliability of the whole system, with failure of the Ballast in case it is an electronic one.

### OBJECT OF THE INVENTION

Main object of the invention is that of reducing as more as it is possible the length of the cables connecting the igniter with the lamp, thus making the device subjected to reduced wearing.

Another object of the solution according to the present invention is that of allowing to realise a less expensive device, thanks to the saving of said high performance cables necessary to transport the high power and voltage.

Another object of the present invention is that of providing a device allowing an easy movement of the lamp, to easily focus the light beam.

A further object of the present invention is that of providing a more versatile device with respect to the known ones thanks to a better compactedness and lightness of the system

Still another object of the present invention is that of providing a device allowing to eliminate the noise created by the pulse generator, caused by the frequency and high tension.

### SUMMARY OF THE INVENTION

It is therefore specific object of the present invention a device for switching on and powering discharge lamps comprising at least a current limiting device, at least a square wave generator, at least an igniter, at least two high tension connection cables, at least a lamp holder with at least a discharge lamp coupled, said at least one igniter comprising at least a high tension transformer and at least an overlapping transformer, said device being characterised in that said at least an igniter is divided into a first stage of the igniter, or pulse generator transformer, and a high tension transformer, and in that said first igniter stage, or pulse generator transformer, and the relevant high tension transformer are assembled along with the above mentioned components.

Preferably, according to the invention, said at least a first stage of the igniter, or pulse generator transformer, is fixed to the lamp holder.

Still according to the invention, said at least a first stage of the igniter, or pulse generator transformer, can integrally move along with the lamp holder.

Always according to the invention, said at least current limiting device module can be connected by two reduced section cables with said at least said at least first stage of the igniter, or pulse generator transformer.

Still according to the invention, connection cables between said at least a current limiting device module and said at least a first stage of the igniter, or pulse generator transformer, can be subjected to movement and/or traction.

Always according to the invention, said at least a first stage of the igniter, or pulse generator transformer, comprises at least a transformer.

Preferably, according to the invention, said at least a first stage of the igniter, or pulse generator transformer, comprises two transformers.

Furthermore, according to the invention, said at least a transformer is comprised of a toroidal core.

Always according to the present invention, said two transformers are comprised of two toroidal nuclei.

Still according to the invention said toroidal core transformer eliminates the noised caused by the square wave, when the system works according to a Flicker-free mode.

Furthermore, according to the present invention, use of toroidal nuclei for the overlapping transformers allow a reduction of dimensions, promoting a reducing assembling.

The present invention will be now described, for illustrative but not limitative purposes, according to its preferred embodiments, with particular reference to the figures of the enclosed drawings, wherein:

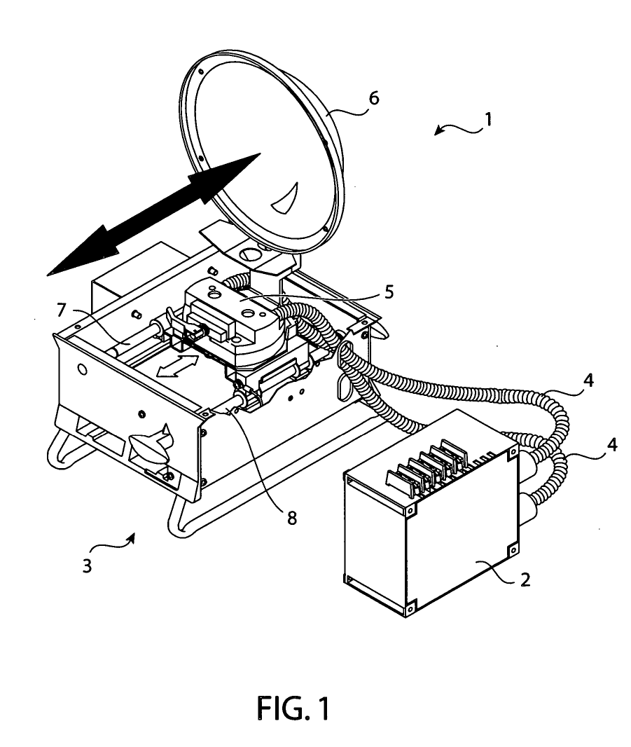

FIG. 1 is a partially cut away perspective view of a powering device for discharge lamps according to the known art;

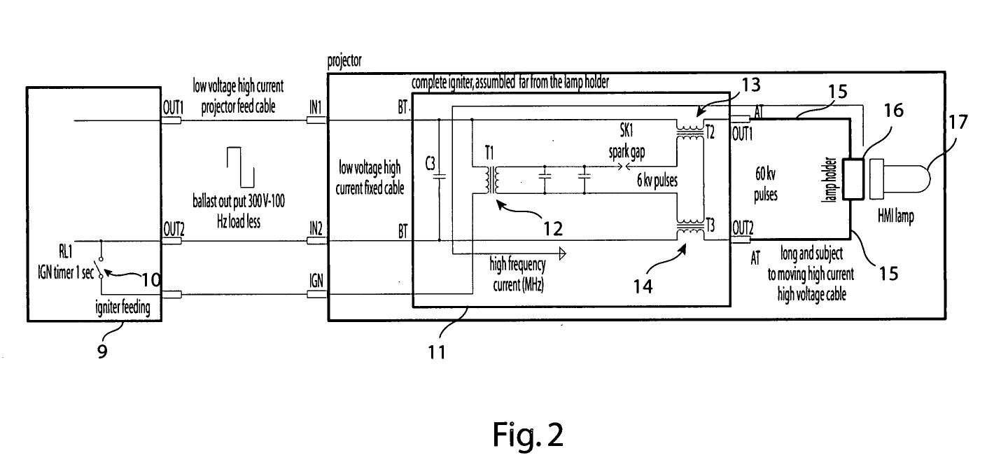

FIG. 2 shows the electrical scheme of the lighting system according to the figure;

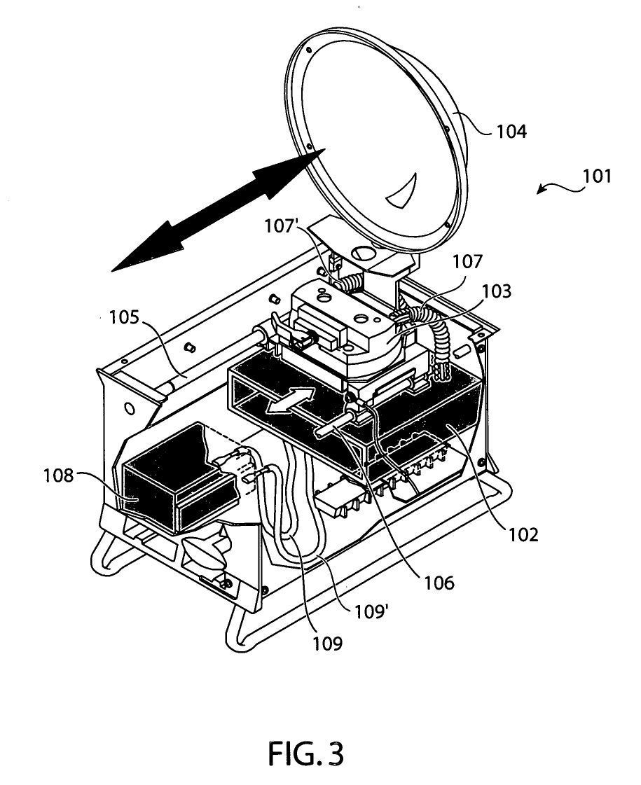

FIG. 3 shows a partially cut away perspective view of a powering device for discharge lamps according to the present invention;

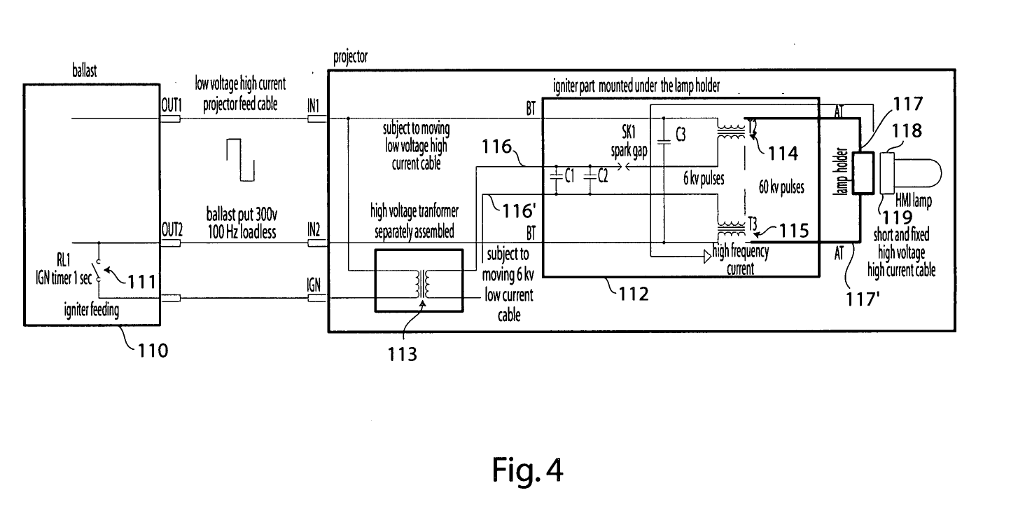

FIG. 4 shows the electrical scheme of the lighting system according to the figure;

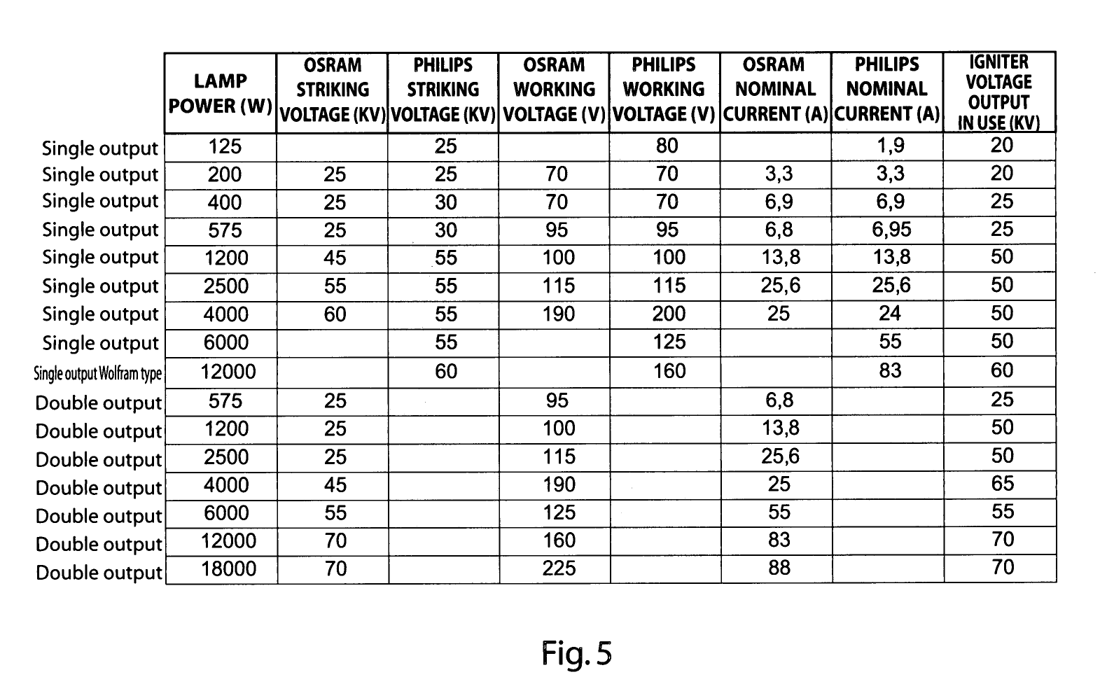

FIG. 5 shows a table describing the electrical switching features of discharge lamps presently available on the market;

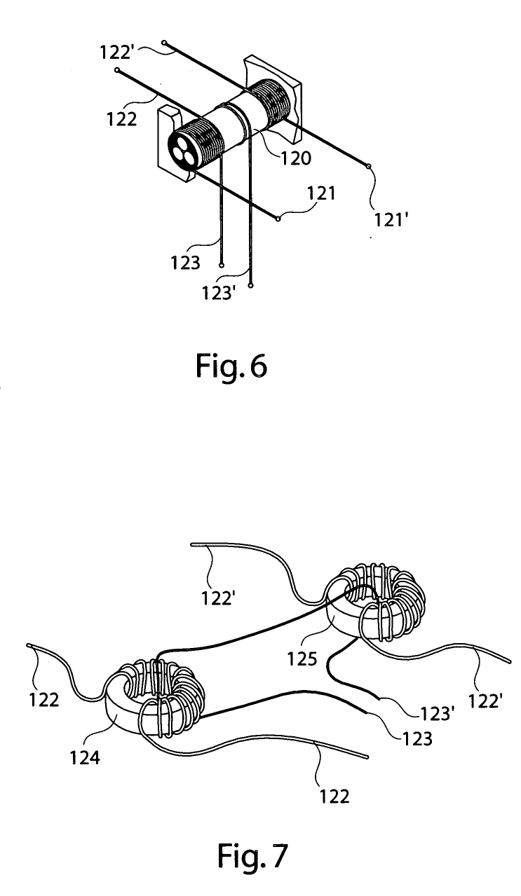

FIG. 6 shows a cylindrical core overlapping transformer; and

FIG. 7 shows a toroidal core overlapping transformer.

FIG. 1 shows a device for powering discharge lamps, comprising an igniter 2 for generating tension and current necessary for switching on discharge lamps, particularly when hot. Said igniter device 2 is physically separated from the movable container 3 wherein all the remaining lamp powering means are provided. Furthermore, it is possible to observe cables 4 connecting igniter 2 to the movable container 3; these cables, due to the high tension, must have very stringent technical features and are subjected to a strong wear. In the figure it can be also seen the lamp holder 5, to which cable 4 and the discharge lamp 6 are connected. Lamp holder 5 is also connected to two guides 7, 8, along which it can slide to focus the light beam this creating an optimum lighting.

FIG. 2 shows the electrical scheme describing a lighting system according to the known art. sub-circuits are graphically insulated in order to put into evidence the parts having different functions. In detail, the figure shows the principle scheme of the power supply of the projector, comprising a Ballast current limiting device 9 and a relays 10 controlled by a pulse generator (not shown in the figure), to generate a square wave signal. Generated square wave signal, typically having an amplitude of 300 Volts and a frequency of 100 Hz, at the output of the Ballast current limiting device 9 is sent to the igniter 11, physically separated from the system. From said circuit, it is possible to observe the high tension transformer 12 and the overlapping transformers 13, 14, necessary to raise the tension of the signal at the output of the Ballast current limiting device 9. Signal, at the output of the igniter 11 arrives at the lamp holder 16 through the high tension connection cables 15, that are, in the physical realisation of the circuit, outside the system and are those more subjected to wearing. Discharge lamp 17 is coupled to the lamp holder 16.

FIG. 3 shows a partially cutaway section of device 101 according to the present invention. In the figure it is possible to note the first stage of the igniter, or transformer of the pulse generator 102, placed under the lamp holder 103 and integral with the same. Lamp 104 is fixed to the lamp holder. By this solution, when the lamp holder 103 slides along the guides 105 and 106, high tension cables 107 and 107′ are not subjected to any stress or motion, since also them integrally move with the lamp holder-lamp-igniter system. Further, said cables 107, 107′ are very short, thus eliminating the problem of the capacitive connections. Within the container it is present, separated with respect to the first stage of the igniter, or transformer of the pulse generator 102, the high tension transformer 108. Said high tension transformer 108 is connected by to small section wires 109, 109′ to the first stage of the igniter, or transformer of the pulse generator 102. Wires 109, 109′ are subjected to the movement due to the displacement of the lamp holder-lamp-igniter system. They displacement does not create technical problems, in fact, thanks to the fact that they must not sustain very high voltage (about 6 kVolts), are not subjected to parasitic capacitive connections or to wearing, further, due to their reduced section, about 1 mm², are economic. Said wires 109, 109′, having the above technical features, represent a completely different technical constraint with respect to he problems of the high tension connections of the standard igniters, as described in the above.

FIG. 4 shows the electrical scheme of the powering discharge lamp. It is possible to note the Ballast current limiting device 110, and the relevant relays 111, controlled by a timer (not shown). Circuit of the first stage of the igniter, or transformer of the pulse generator 112 comprises overlapping transformers 114, 115, while high tension transformer 113 is connected to the others by connections 116, 116′ schematically representing movable cables 109, 109′ of the previous figure. Said transformer 113 is physically separated from the other parts of the circuit of the first stage of the igniter, or transformer of the pulse generator 112. High tension cables 117, 117′ are in the scheme particularly short and, mainly, fixed, i.e. not subjected to movement. Said cables 117, 117′ connects transformers 114, 115 with the lamp holder 118 to which the discharge lamp 119 is connected.

As reference, in FIG. 5 it is indicated a table comparing the power absorbed by the various discharge lamps available on the market. It can be seen that for some models striking voltage can even reach 70 kVolts.

Finally, FIGS. 6 and 7 are enclosed, showing the two different embodiments of the ovelapping transformers. Particularly, in FIG. 6 it is shown transformer providing two windings, with a cylindrical core. The latter has a ferrite cylindrical core 120, thus connecting the lamp holder by the cables 121 and 121′, the Ballast current limiting device by the cables 122, 122′ and the pulse generator by the cables 123, 123′.

In FIG. 7 it is suggested the use of two toroidal core transformers 124, 125. The latter has different technical and constructive advantages, as follows:

Allowing to use rather squeezed shapes thanks to the geometry of the employed components;

Eliminating the noise determined by the passage of a strong square wave current, since iron dust nuclei, thanks to their shape and to the technology employed in their manufacturing, are not subjected to magnetostriction phenomenon, characterising ferrite bar cylindrical nuclei.

It exists a further advantage obtained by the use of toroidal nuclei: it is possible to use standard cables, suitably insulated, to realise the windings. In the figure it is possible to observe connections 121, 121′ with the lamp holder 103, connection with Ballast current limiting device by cables 122, 122′ and connection with pulse generator by cables 123 and 123′.

The present invention has been described for illustrative but not limitative purposes, according to its preferred embodiments, but it is to be understood that modifications and/or changes can be introduced by those skilled in the art without departing from the relevant scope as defined in the enclosed claims.

1. Device for switching on and powering discharge lamps comprising at least a current limiting device, at least a square wave generator, at least an igniter, at least two high tension connection cables, at least a lamp holder with at least a discharge lamp coupled, said at least one igniter comprising at least a high tension transformer and at least an overlapping transformer, said device being characterised in that said at least an igniter is divided into a first stage of the igniter, or pulse generator transformer, and a high tension transformer, and in that said first igniter stage, or pulse generator transformer, and the relevant high tension transformer are assembled along with the above mentioned components.

2. Device for switching on and powering discharge lamps according to claim 1, characterised in that said at least a first stage of the igniter, or pulse generator transformer, is fixed to the lamp holder.

3. Device for switching on and powering discharge lamps according to claim 1 or 2, characterised in that said at least a first stage of the igniter, or pulse generator transformer, integrally moves along with the lamp holder.

4. Device for switching on and powering discharge lamps according to one of the preceding claims, characterised in that said at least current limiting device module is connected by two reduced section cables with said at least said at least first stage of the igniter, or pulse generator transformer.

5. Device for switching on and powering discharge lamps according to claim 4, characterised in that connection cables between said at least a current limiting device module and said at least a first stage of the igniter, or pulse generator transformer, are be subjected to movement and/or traction.

6. Device for switching on and powering discharge lamps according to one of the preceding claims, characterised in that said at least a first stage of the igniter, or pulse generator transformer, comprises at least a transformer.

7. Device for switching on and powering discharge lamps according to claim 6, characterised in that said at least a first stage of the igniter, or pulse generator transformer, comprises two transformers.

8. Device for switching on and powering discharge lamps according to claim 6, characterised in that said at least a transformer is comprised of a toroidal core.

9. Device for switching on and powering discharge lamps according to claim 7, characterised in that said two transformers are comprised of two toroidal nuclei.

10. Device for switching on and powering discharge lamps according to claim 8 or 9, characterised in that said at least one transformed comprised of a toroidal core allows a reduction of dimensions, promoting a reducing assembling.

11. Device for switching on and powering discharge lamps according to each one of the preceding claims substantially as illustrated and described.
